(19) United States
(12) Patent Application Publication
(10) Pub. No.: US 2008/0082399 A1
(43) Pub. Date: Apr. 3, 2008

(54) METHOD AND SYSTEM FOR COLLECTING, ORGANIZING, AND ANALYZING EMERGING CULTURE TRENDS THAT INFLUENCE CONSUMERS

(76) Inventors: Bob Noble, Springfield, MO (US); Brad Noble, Springfield, MO (US); Stuart Alexander, Springfield, MO (US); Leslie Hutter, Republic, MO (US); Andy Ford, Springfield, MO (US); David Toothaker, Fayetteville, AR (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/864,356

(22) Filed: Sep. 28, 2007

Related U.S. Application Data
(60) Provisional application No. 60/827,341, filed on Sep. 28, 2006.

(51) Int. Cl. G06Q 30/00; G06F 17/30; G06F 17/40

(52) U.S. Cl. 705/10

(57) ABSTRACT

The present invention relates to a method and system of collecting, organizing, and analyzing data, and more particularly, to a method and system of collecting data and grouping the data to determine culture segments and emerging culture trends that influence consumers and identify target affinity groups.

### CROSS REFERENCE TO A RELATED APPLICATION

The present application is based on Provisional Patent Application Ser. No. 60/827,641, which was filed on Sep. 28, 2006, which is incorporated by reference.

### FIELD OF INVENTION

The present invention relates to a method and system of identifying, collecting, organizing, and analyzing data to determine trends and identify culture segments and the affinity groups of consumers influenced by the culture segments. The data information may be used to identify an emerging trend as being popular with a specific group of people, i.e. culture segments or culture trends, whereby the emerging trends identified can be applied to business development. By identifying the culture segments and the affinity groups a specific group of consumers that share similar consumption and choice characteristics are identified.

### BACKGROUND OF INVENTION

Business development is a term that is used to describe the growth and sustainability of a business. Areas of business development include but are not limited to marketing, business creation, business growth, positioning, and strategic product or service development. Each of these distinct areas are employed to maximize the development and strength of a business.

Marketing is one example used to increase sales and business growth by alerting consumers through advertisements to the products or services that a business provides. The advertisements are geared to influence consumers to purchase a product or service. Many businesses use media and other related sources of consumer stimuli to market goods and services to potential customers. Businesses attempt to reach and retain customers through marketing programs and advertisements. The goal is to maximize consumer interest in their product or service, leading to increased sales. Success of a particular advertising campaign is dependent on factors such as, targeting an appropriate audience, peaking the interest of the target audience, and drawing an association between the product and the audience. An efficient advertising campaign minimizes the budget, but maximizes the influence on consumer behavior. Determining how to efficiently and optimally target a consumer audience poses a daunting challenge to advertisers.

It is well known in the industry to use consumer marketing research to study consumers and their purchasing habits based on prior buying behavior. Current marketing research only relies on historical trends to develop advertising campaigns. This type of research is considered “behavioral research” and is defined as the study of what consumers have purchased in the past. It is taught that by obtaining this information a correlation can be drawn that will anticipate the purchasing decisions of consumers in the future. Thus, it is believed future marketing programs and advertisements can be designed to influence the targeted consumer. Problematically, this methodology fails, because new trends are likely not identified. The historical data focuses on those goods and services that have already been sold to consumers, this does not take into account new products or services, nor does it consider changing factors and influences. Historical data is also not a good predictor of future consumer consumption as new trends are continually emerging. Obviously, businesses that can identify the trends early gain an advantage in the marketplace.

Using past consumer behavior to anticipate future purchasing has been difficult to implement and incorporate into marketing programs and advertisements. First, collecting a consumer's purchasing history is difficult. Sales data, typically, takes months if not years to accumulate. Further, the amount of information collected on consumer purchasing is voluminous with the large amount of data rendering the review of the information prohibitive, because of the time and resources to process. Second, the purchasing history only accounts for past practices and does not aide in the discovery of future emerging trends. Third, branding equity has begun to lose favor with consumers. Branding equity in the past is what businesses relied on to maintain consumer interest. In the past, once a brand had developed recognition among consumers, little thought was put into reinventing the brand, instead the brand perpetuates sales. Over time, and because of the numerous and ever changing choices available, it has been observed that consumers continually look for new concepts or new marketing campaigns that reinvent existing products, services, ideas, or concepts. Finally, purchasing history does not provide the reason why a consumer purchased a particular product or service.

One problem with models and techniques currently used for identifying and implementing advertising campaigns, or targeting a specific consumer affinity group, is the lack of identifying and incorporating emerging trends. In the past, brand equity was a strong predictor of success in relation to marketing programs and advertisements. This influence has shifted and the old ways of assessing consumer needs and potential consumer purchasing has changed. The marketplace is currently shifting to reward marketing programs that include fresh insight and emerging consumer trends when compared to historical brand equity. Further, advertising campaigns that include emerging concepts and reference or include historical trends and concepts, create a campaign focused on target affinity groups.

Without a more effective system to identify and capitalize on emerging trends, marketing programs and advertising campaigns are limited in the ability to produce effective influences on purchasing consumers. Without market programs and advertising campaigns focused on the future trends that will influence consumers, marketing resources are wasted resulting in an unnecessary loss of revenue. The current problem is the ability to develop a predictive model that is not reliant on past trends. What is desired is a method designed to identify new consumer classes or targeted affinity groups.

In view of the above-described shortcomings related to the analysis of consumer influences, there exists a need in the art for a method and system for the identification, collection, organization, and analysis of data related to emerging culture trends that are likely to influence consumers and will aide business development. More specifically, there exists a need for a method and system for identifying collecting, organizing, and analyzing data on emerging culture trends and further incorporating this information into future business development including marketing programs and advertisement campaigns targeting specific consumer groups, strategic development of new product lines or services, business positioning, new business creation, and overall business growth and sustainability.

Typically, consumers purchase something based on a need and what relates to them on a personal level. Emerging trends that focus on the consumer's need at a personal level are considered “cool” by a specific affinity group of consumers. By creating a connection between a new trend and a consumer, the product or service appeals to the consumer on both a need and affiliation level. The individual has a desire to belong to the “new” group and is motivated by the trend. Business development, including marketing or new product or service development, is more effective when it is personalized and predictive, as opposed to group oriented and historical in nature. Thus, a method of identifying trends for business development to increase growth or revenue streams is desired. Further, a method for identifying emerging trends for incorporation into a marketing model, as opposed to historical data, is desired. Further, the identification and correlation of new trends with past established mainstream market trends, for use in creating marketing campaigns, is also desired.

### SUMMARY OF THE INVENTION

The present invention relates to a method and system for collecting, organizing, and analyzing data to identify culture segments and potential trends that influence consumers. Further, the method identifies specific affinity groups influenced by the culture segments in order to target specific consumers for future business development. In particular, the method identifies emerging trends, concepts, ideas, products, or services and the affinity group of consumers that are influenced by the emerging trends. The method illustrates what will influence consumer purchasing behavior. Further, the emerging trends are correlated with current and past established trends in order to identify affinity groups influenced by the past trends that will also be influenced by the emerging trends. The information collected on consumer items and the emerging trends add to or create a new culture segment and are also used to continually refine the current affinity group that is influenced most. Identifying emerging trends, culture segments, and the affinity groups influenced allow for creation of business development plans intended to target specific affinity groups. Business development programs that will use this information include marketing, business creation, business growth, positioning, and product or service development.

Marketing is an area of business development that the present invention will aide for growth and sustainability of a business. Identifying a culture segment and the target affinity group will help in the creation of a marketing campaign to influence the buying habits of a consumer. A marketing campaign using the present method of targeting an affinity group based on defined consumer preferences is an improvement from the typical industry standards for marketing to consumers based on other descriptors, such as geography or age. Targeting a defined affinity group based on the affinity groups relationship to a culture segment and potential emerging trends allows the development of a more focused and better tailored marketing campaign that will require fewer resources to appeal to the targeted consumer.

The present inventive method includes collecting data, tagging the data, inputting the data into a database, monitoring and updating the data, compiling data into groups based on search queries to create culture groups, creating a potential culture segment based on a culture group, further grouping the culture segments into colony culture segments, defining the consumer affinity group associated with the culture segment and publishing the culture segments, and using the culture segment, colony culture segment groups, and affinity groups for business development.

The method begins by collecting data on a range of items from emerging and current trends, concepts, products, services, goods, ideas, messages, or any consumer stimuli. The collected item comes from numerous consumer sources that include, but are not limited to, media outlets, advertisements, movies, television and radio programs, books, magazines, internet websites, blogs, chat rooms, newspapers, or any other source with related, relevant, or information viewed by consumers. Additionally, the item will be tagged, which includes collecting and associating information relevant to the item to define any stimuli or information that will influence a consumer. Typically, the areas of consumer life stimuli are divided into four categories that include entertainment, technology, design, and well being. These categories are not exhaustive of the areas that influence consumers but are rather an example of how consumer stimuli can be categorized. After an item or potential data point has been discovered, as much information about the item is collected, and further input into a database where it is monitored and updated.

After the discovered item is collected and input into the database as a data point the information is monitored and updated. Monitoring allows addition information collection and tagging of the item and aides in determining the likelihood that the item discovered will develop into an emerging trend and potentially a mainstream trend. Monitoring the data point crosschecks and rechecks the information collected and tagged for associating with the item, ensuring the information was not an aberration. Additionally, monitoring the data point allows the continual review and collection of information related to the item and provides an overview progression on the development of the data point.

Collection of items and associated information lead to categorizing the concepts under a particular emotional driver. Emotional drivers have been defined by the Maslow Needs Hierarchy and relate to the instinctual needs that motivate an individual. (Toward a Psychology of Being, Maslow, (1968), herein incorporated by reference.) Instinctual needs are innate needs felt by humans with a causal relationship to certain behaviors. Maslow's theory is demonstrated as a pyramid hierarchy. The pyramid is arranged from bottom to top with five basic instinctual needs: 1) physiological; 2) safety; 3) love; 4) esteem; and, 5) self-actualization. Those needs categorized at the pyramid base (physiological) are the strongest. The needs weaken the higher the placement on the pyramid. The higher the need is on the pyramid, such as self-actualization the more it is distinctly human.

Since all emotional drivers are categorized under the Maslow Model, each data point or item must be placed in at least one of the five categories. By placing the item under one of Maslow's emotional drivers certain distinguishing characteristics about the item are learned. Further, matching the emotional driver with the item provides a reason why a consumer will be motivated by the item. As such, Maslow is applied to the item to determine who would be influenced by a particular trend.

After the informative data is collected and the item is tagged with the associated information such as emotional driver and consumer life stimuli, the items are grouped into trends known as culture segments. Culture segments are a group of items that cause similar influences on a consumer. Typically, trends are created and further grouped together based on similar instinctual drivers that will motivate a consumer. Similar item posses certain similar characteristics that influence consumers. Creation of culture segments focus on using the similarities of past and potentially similar consumer influences to target future consumers that will likely be drawn to an emerging item, concept, or trend. The emerging items or concepts are matched or paired with already identified mainstream or growing trends creating a correlation for targeting a specific consumer. Associating an emerging item or concept with a culture segment helps identify a specific affinity group of consumers and the motivation associated with the emerging item and concept that will influence the consumer. As such, culture segments are created which include both past and present trends and emerging trends.

The creation of the culture segments can then be used in future business development. Examples of this would include marketing development, strategic development of new products or services, creation of a new business or new products or services, or general business development with the insight of how consumer interests have changed and the affinity group that will be influenced by the culture segment.

It is also possible after the culture segments are created to further group the culture segments into colony culture segments. Colony culture segments are a mixture of culture segments that influence a targeted affinity group. Similar characteristics based on consumer or affinity groups influenced by a culture segment and how the culture segments are similar, lead to a more defined affinity group. By further creating a colony culture segment the affinity group that is most influenced by the colony culture segment can be targeted.

Using either the culture segments or the colony culture segments the affinity group influenced is further defined. Once the affinity group is identified a business can use this information for implementation into future development. Further, emerging trends that will influence specific affinity groups can be used to tailor the development of future business endeavors including marketing, business creation, product or service development, or other strategic business planning. The identification of not only emerging trends but those specific affinity groups that will be influenced by the trend creates opportunities for business growth and sustainability. Thus, three groups are formed culture segments, colony culture segments, and affinity groups with all three somewhat interdependent.

### BRIEF DESCRIPTION OF THE DRAWINGS

FIG. 1—is a block diagram of the steps of the invention.

FIGS. 2 and 3—are hypothetical examples of a computer program process or system demonstrating the steps for creating a culture segment or assigning an item to a culture segment, for future business development.

FIG. 4—is a representative example of the Maslow Hierarchy of needs pyramid.

### DETAILED DESCRIPTION OF THE PREFERRED EMBODIMENT

The present invention relates to a method and system for collecting, organizing, and analyzing data to identify culture segments and trends that influence consumer purchasing habits. Further, the method identifies culture groups in order to target specific consumers for future business development. In particular, the method identifies a culture segment through the grouping of emerging to mainstream ideas, products, concepts, or trends that are preferred by a specific affinity group of consumers. By identifying the culture segment and subsequent emerging trends and correlating the emerging trends with past established trends the consumer affinity groups that will most associate with the emerging trend is identified resulting in a targeted audience. Once an audience of consumers is targeted a business can tailor future development toward the affinity group based on the groups preferred tastes. One aspect of business development is accomplished through an advertising campaign for a product or service tailored to the specific consumer affinity group. Identifying the culture segment and influenced target affinity group will help in the creation of a marketing campaign to influence the buying habits of a consumer. The marketing campaign is designed to focus on a specific affinity group based on defined consumer preferences, not the typical industry standards such as geography or age. By targeting a defined affinity group based on emerging trends, a better marketing campaign is developed that will require fewer resources to target the consumers.

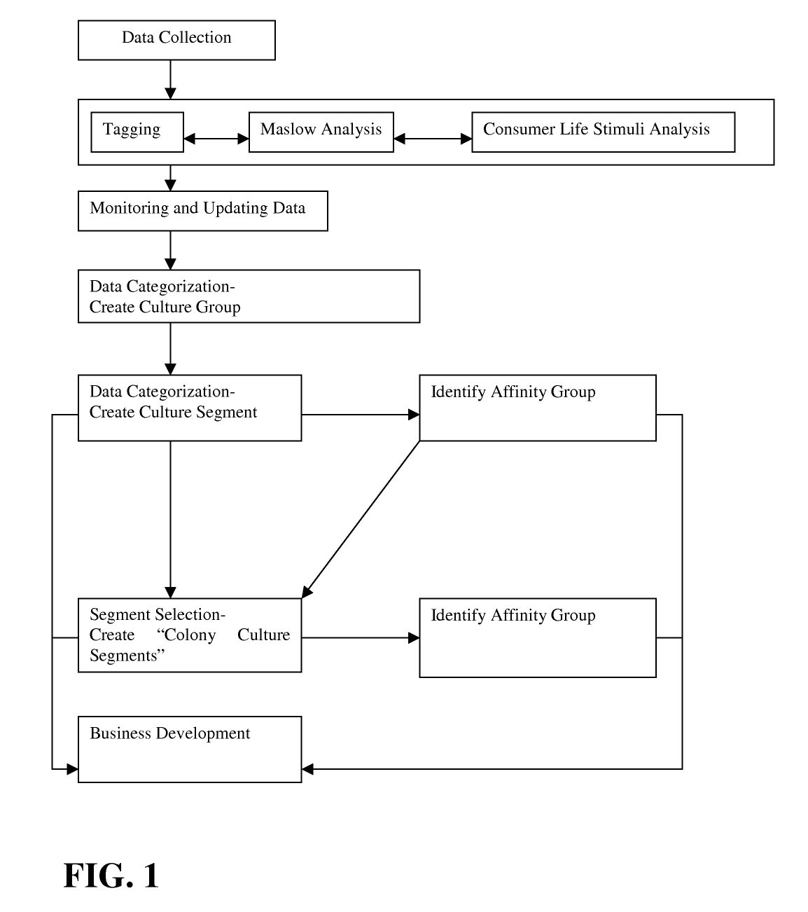

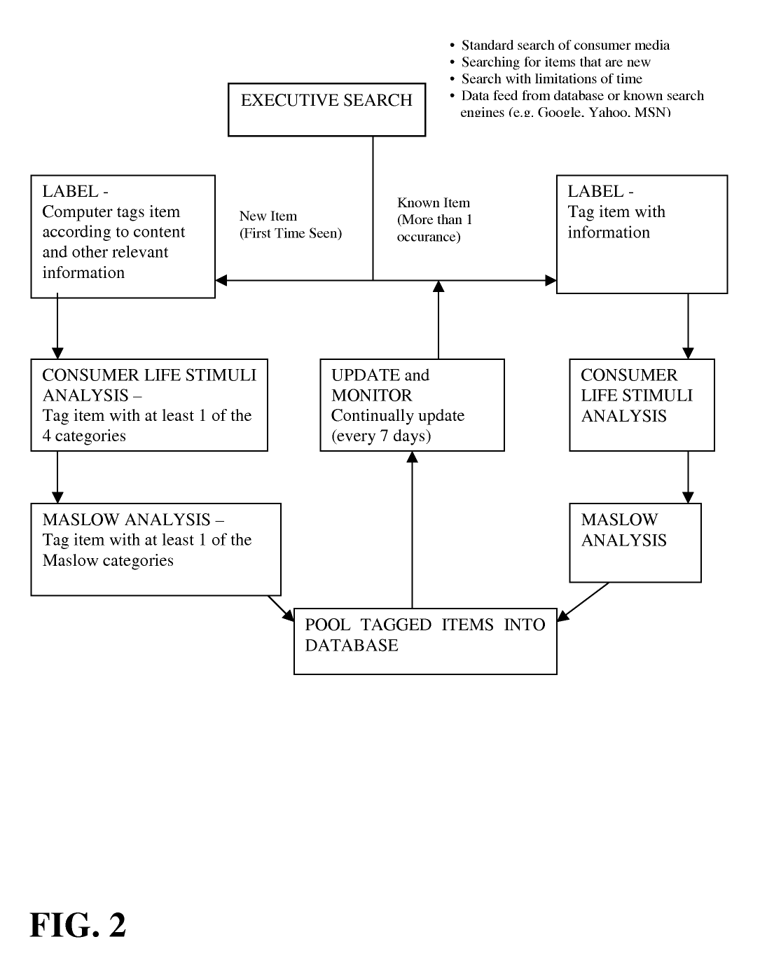

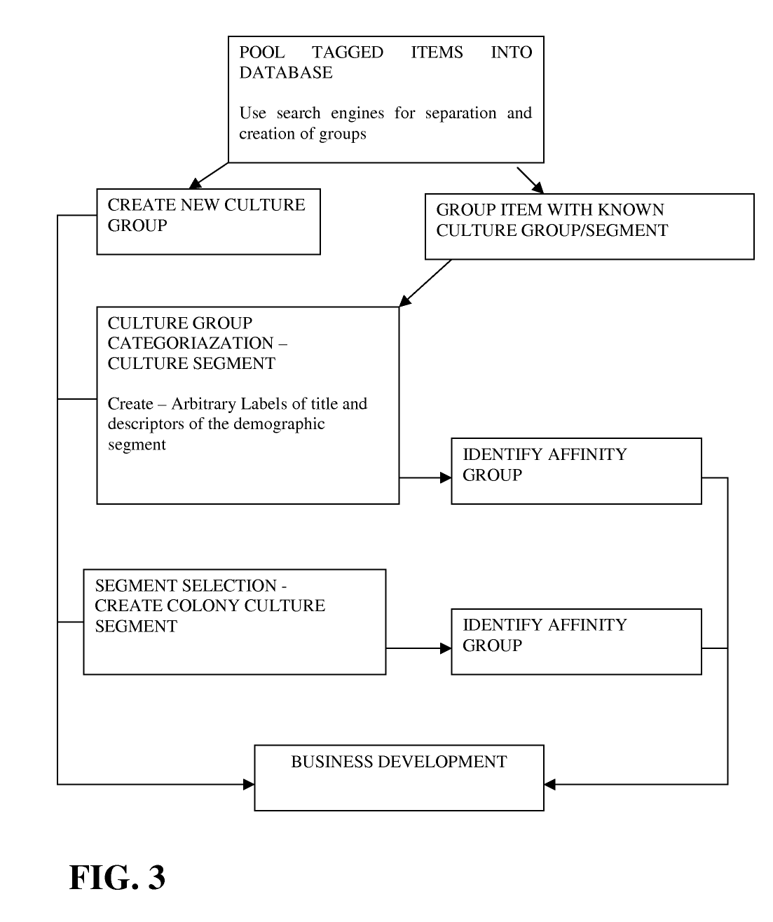

The main steps for the method to identify emerging trends in the market place and creating culture segments are shown at FIG. 1. The examples provided are directed to identifying culture groups, culture segments, and further to the identification of emerging trends associated with a specific culture groups and further the affinity group of consumers associated with the culture group and emerging trend. But, the present invention is not limited to this application, and it is clear that the principles and methods of the present invention can find applications in numerous other settings, including developing groupings of current trends to target specific affinity groups.

The method of FIG. 1 includes collecting data, tagging the data, inputting the data into a database, monitoring and updating the data, compiling the data into groups based on search queries to create culture groups, creating a potential culture segment based on a culture group, further grouping the culture segments into colony culture segments, and publishing the culture segments and colony culture segments as well as the affinity groups associated with the culture segments and colony culture segments. The method can further include using culture groups, culture segments, and colony culture segments to identify affinity groups, trends, influence business development and decisions, develop marketing programs, create advertising campaigns, and develop branding identities for consumer and business products and services.

Data Collection and Tagging

To begin the method for determining a culture group or an emerging trend that will likely influence an affinity group of consumers, data is collected. The data is not based on past buying trends or past behavior, nor is it used to determine typical consumers demographic groups such as age, sex, race, socioeconomic, etc. Instead, the data relates to emerging concepts, products, goods, ideas, messages, or cultural movements and is used to define a culture group such as a class, affinity group, or population of consumers with similar purchasing habits. More importantly, the data helps identify a particular class, affinity group, or population that is influenced by similar media or consumer stimuli and that can be influenced to embrace a product or service based upon an appeal to the class's defined hierarchy of needs. In particular, the class is more attracted to particular goods or services that are identified or associated with a particular message (movement) or emerging trends rather than the typical consumer demographic they may fall within.

The data collected comes from numerous consumer sources that include, but are not limited to, media outlets, advertisements, movies, television and radio programs, books, magazines, internet websites, blogs, chat rooms, newspapers, or any other source with related, relevant, or viewed information by a consumer. Any source for information can be reviewed if the source harbors or identifies potential information for emerging products, goods, ideas, messages, or cultural movements to which consumers may ultimately gravitate. Sources will include any form of media stimuli that is used to reach potential customers or consumers. Consumer culture and market trends are typically driven by four categories but can include additional categories and variations. The categories include, but are not limited to the areas of entertainment, technology, design, and well being. These categories are consumer driven. Most products will fall under more than one category with the degree associated with the category varied. Examples of products or services for each category include: design—furniture, clothes, shoes, fashion styles, and non-perishable products; entertainment—movies, literature, plays, TV shows, sports and sporting events; technology—computers, ipods, software, GPS systems, cell phones, and pdas; and, well-being—food, beverages, spas, lotions, and perishable products. The above information provides a few examples of the types of products, services, or information available for consumers. The sources reviewed are designed to provide a snapshot of current consumer stimuli. And, identify those emerging ideas or concepts that have the potential to develop into the future emerging, developing (growing), or established market trends. The resulting data includes contextual information on the item and can be categorized in more than one class. A tag is applied to distinguish and define the data.

A person or computer can be used to collect the data. In one embodiment, a person is used to collect the data. The person collecting the data is referred to as a sifter or cultural anthropologist. They are individuals who have experience with consumer culture, specifically in areas such as entertainment, technology, design, and well being. Their experience provides a background that helps filter the data and aide in the discovery of emerging concepts or the defining and recordation of known consumer stimuli. Because consumer driven categories, within entertainment, technology, design, and well being, continually change, the data collected will constantly cycle through emerging, developing (growing), and established trends as consumer desires change. The data collection step filters the numerous items, such as concepts, products, services, goods, ideas, messages, or any consumer stimuli and aides in organizing the data for future use. In addition it provides the first step for identifying information, including new and established trends and where on the cycle of the spectrum the information falls.

In another embodiment, a computer program is used to collect the data. Similar to the sifter described above, the computer program is designed to collect information. The computer program searches the consumer stimuli sources through the use of keyword or phrase searches, content search, or advance feature searches. These searches are currently known in the industry and are employed on large scale by many leading search engines providers such as Google, Yahoo, MSN, AskJeeves, and Hotbot. The searches are designed to filter information and target specific concepts, ideas, products, services, or other information. In one embodiment, the program collects data on emerging concepts. The program identifies items such as, concepts, ideas, products, services, or messages not previously seen in the consumer stimuli sources. In another embodiment, the computer program uses keyword searches to identify items that are already established in mainstream culture. By using a computer program numerous sources can efficiently be searched and filtered in order to discover and compile relevant information on the items sought. The program then puts the items in one or more of the consumer life stimuli categories, once it is tagged in a category the item is further filtered into sub categories for additional collection and tagging.

Regardless, if a person or computer program is used to collect the data, the collector starts by identifying information for an item, such as concepts, services, ideas, products, or any other consumer stimuli. Each unique item and the related or defining information collected becomes a data point. These data points will include information that is emerging in the market, well-established within mainstream culture, and has lost favor with the mainstream culture, as well as all the levels within the cycle of emerging, growing, mainstream, and post mainstream. The collector reviews numerous sources during the data collection step in order to identify as much information on an item as possible, and record as many items as possible. Once identified, the collector will tag the item or data point. In another embodiment a computer will tag the item or data point. Tagging is the act of assigning information to the item for classification purposes in order to better define the item. In addition, other sources will be reviewed or monitored to see if that data point is described or mentioned in another source. A data point will generally be something that is new either newly discussed, such as a brand new concept or product, or has not been in circulation for a period of time, typically 5 years, or is an item that is minimally known but shows up in the monitoring phase or more separate sources. In another embodiment, the data point can be any item that is collected in the collection phase regardless if it is a new item.

Tagging the data point is accomplished through the collector assigning and recording pertinent information on the item. As much information is recorded on the item in order to define the item, and is accomplished through the association of certain criteria or information for future analysis. If the collector is a human the collector will manually enter the information on the item to create a data point that will be recorded in a database. In another embodiment, the collector is a computer and will record the information selected as relevant as the search is conducted. The recordation of the information by the computer will be similar to that of human collectors and will include the recordation of the relevant information that is associated with the item as it is discovered. This includes collecting information from the sources, content associate with the item, and surrounding contextual information. The tagging of the item is similar to the parameters used for a general search, whereas information surrounding or defining the item is associated with the item and recorded for future reference.

The information collected on the item includes numerous places to record information specific on the item identified. The information fields are used to collect as much information on who, what, when, and where about the item that later are used to define the motivations behind it that will influence consumers. The information recorded can include but is not limited to information on the potential target audience, including demographics related to age, sex, economic status, race, and religion, the area of consumer life stimuli that include entertainment, design, technology, and well-being, where the data was discovered, when the data was discovered, and how many instances the item was demonstrated during the search. Information collected will include: 1) a brief clip or example of the item; 2) where the item was discovered, such as on a website, and the link to the website; 3) who the likely target age group that will be most influenced or relate to the item; 4) what context or other information related to the item was included at the sources, this provides the background and contextual information on the item; 5) what category the item is most closely related for consumer life stimuli, such as design, entertainment, technology or well-being, the categorization of the item under these area aide in the categorization and grouping of the items; 6) how the item relates to consumers emotionally, this will include key terms or synonymous words that are associated with the item; 7) general comments created by the collector on the item; 8) the emotional driver as defined by the Maslow Needs Hierarchy that is most closely associated with the item; and, 9) any miscellaneous information that distinguishes the item.

In one embodiment, the collector is only interested in collecting data on items that are considered emerging. Emerging items are those ideas that have not gained mainstream notoriety. Typically, an emerging item is viewed as a novel or relatively novel concept or item. The collector only comes across an emerging item in limited instances during the search. At most the emerging item is seen five times or less during the collection phase of the data. After the data has met the criteria to be considered an emerging item, it is recorded as a data point with the tagging information recorded and logged in the database.

In optional embodiments, the collector can identify developing (growing) or established items and the trends associated with each. If the collector is interested in collecting data related to developing or established items or concepts and trends, the collector will record and tag the relevant information related to the item as discussed above, further recording the number of instances the item or trend is seen during the search. Collecting information on the number of instances an item or trend is viewed helps determine where on the spectrum of notoriety (growing to established) the item or trend falls.

Recording the information establishes the item as a potential emerging item. Recordation of the item as a data point is designed to record information about the emerging item and the potential target audience or consumer. Information is continually added to the data sheet as the emerging item is viewed and reviewed during the collection, monitoring, and categorization steps of the method.

The collection and tagging of items as data points is essential to facilitate the identification of culture groups and ultimately culture segments. This is important because data points are assembled to create culture segments based on similarity then given an arbitrary label based on key elements that include the relationship to the Maslow emotional driver and the influence of the consumer life stimuli that are found within the information associated with the item. By recording as much information as possible at the onset an item can easily be categorized as emerging, developing, or established in mainstream. Recording the information related to each item provides the basis for identifying the emerging item and using the emerging item to create a future marketing campaign. Thus, the method is initiated by focusing on and identifying items that have the potential to be grouped into a new culture segment or develop into a future trend and thus become a member of a culture segment.

Monitoring and Updating of Data

After the item is collected, tagged, and input into the database creating the recorded data point, additional monitoring and updating continue. The data point recorded in the database is continually monitored and updated by the computer system with additional tagging of the data point. The additional tagging includes assigning and recording information or recording meta data for each data point including but not limited to: 1) activity, this includes the activity overall, the activity generated by the specific item for both current activity over a predetermined time period such as a week or month, and the lifetime activity of the item; 2) number of occurrences that reference the item; 3) number of related occurrences, such as other media stimuli that reference the item; 4) the application types, activity, and number of occurrences that reference or in some way incorporate the item; and 5) any general information relevant to the item.

In an additional embodiment, the data point is recorded on the “lifeboard” which is simply a device or method for tracking the proliferation of items or related data points. Each data point or item is collected and the information associated with the item is recorded for future categorization. The original source of the data and any new sources are monitored for a period of time, to determine if a data point or emerging concept reflects a growing popularity or notoriety with consumers. The emerging items are continually reviewed to continually collect information and monitor the progress of the item. In one embodiment, the data point is reviewed on a weekly or bimonthly base in order to continually update the information associated with the item. The monitoring and updating process ensures information on the item is continually collected, and the item is monitored for future relevance and strength. After a data point begins to show strength in the marketplace, such as appearing in some form more than once, and typically at least five times in a three-month period it is considered an emerging item that is moving toward a trend. Monitoring may be required in order to collect enough information about a data point or emerging concept to be able to include it on the “lifeboard”. Monitoring the data helps to track and establish when an item is emerging as a trend since in many instances the emerging item is so new that not enough information is known about it.

After information for the data point or emerging item is recorded it is forwarded to a subsequent individual or computer program for review. This second review is used to further evaluate the item to determine if the potential to develop into an emerging trend exists and further into an established mainstream trend. In additional embodiments, more than two reviews of the information related to the data point or emerging item are conducted. Subsequent reviews are used to continually monitor and track the development of the emerging item.

After the second review the concept and data corresponding to the item is recorded on the “launchpad.” The review is conducted to ensure that the informative data associated with the potential item is not an aberration. The item and associated data are reviewed and crosschecked to ensure the data occurs in more than one source and the sources are not related. The review crosschecks all the informative data to ensure the data sources listed are not derived from a single source that simply cites to the original source unless it occurs on multiple occasions. And, the data cannot simply be a synonym or minor variation of established trends. The second and all subsequent reviews are conducted to ensure that the item has the potential to evolve into an emerging trend and later an established trend. By checking and rechecking during the reviews an emerging item is identified and separated from those items that are merely single instances of the same information. Distinguishing those items, which in the future will evolve into emerging trends and subsequent established trends, ensures that future business decisions based on the trends are directed to a desired affinity group.

The second and subsequent reviews can be accomplished by using a human or a computer program. In one embodiment, a human will review the data points and the information collected during the initial information collection and subsequent monitoring step. A human reviews and crosschecks the informative data collected to ensure it is correct and representative of the item associated with the data point. In an optional embodiment, a computer program is used to review the data. The program used will cross check the information by using keyword searches, content searches, and advance search review parameters to ensure it is correct. Regardless if a human review or computer program review is used the information collected during the initial collection step and monitoring step are employed to ensure the information collected is accurate and relevant. After the collection and monitoring steps, the data point is considered an emerging item and is listed on the launchpad.

Data Analysis—Maslow

During the information collection and data monitoring step a psychological review is applied to categorize the particular data point. Collection of the data points and information on the emerging trends lead to the step of categorizing the emerging items based on particular emotional drivers. The emerging items are matched with the emotional drivers that motivate a consumer. In some cases the emerging items satisfy multiple emotional drivers. The emerging item, and related data points and information recorded in the launchpad, is matched with the emotional driver in order to demonstrate what emotional driver is associated with the item that will motivate an individual.

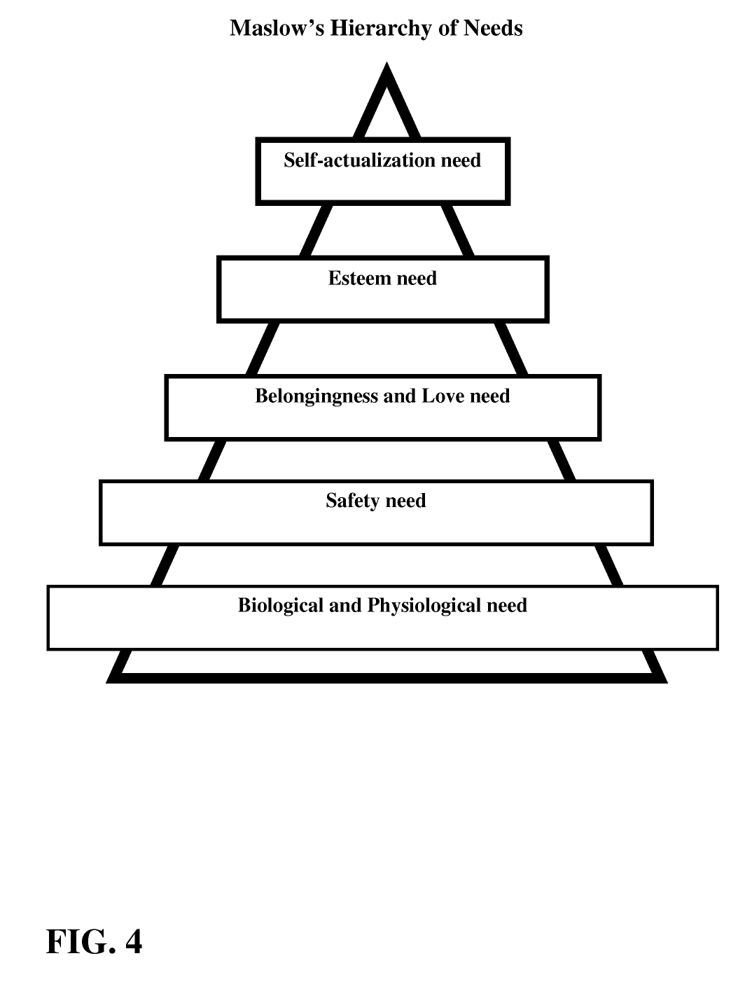

An emotional driver as defined by the Maslow Needs Hierarchy is an instinctual need that motivates an individual. An instinctual need is an innate need felt by humans. Maslow's theory on the nature of human needs is demonstrated in his Hierarchy of Human Needs pyramid, see FIG. 4. The pyramid arrangement focuses on the hierarchy and strength of a need in terms of potency. All needs as taught by Maslow are instinctual, but some are categorized as more powerful than others. Needs at the bottom of the pyramid are the strongest, see FIG. 4. These needs are similar to those possessed by non-human animals. The higher the need on the pyramid, the weaker and more distinctly human it is. Arranged in the order of weakest to strongest inherent needs, are: physiological, safety, love, esteem, and self-actualization. The five basic instinctual needs are further defined as 1) physiological—basic life needs, biological, air, food, drink, shelter, warmth, sex, sleep, etc; 2) safety—protection from elements, security, order, law, limits, stability, etc.; 3) love—belongingness, family, affection, relationship, work group, etc; 4) esteem—self-esteem, achievement, status, responsibility, reputation, achievement, mastery, independence, dominance, prestige, etc.; and, 5) self-actualization—personal growth potential, self-fulfillment, peak experiences, etc. Some additional adaptations of the Maslow Hierarchy have been introduced throughout the years. These models include the additional levels of 6) cognitive needs—knowledge, meaning, etc.; 7) aesthetic needs—appreciation and search for beauty, balance, form, etc; and, 8) transcendence needs—helping others to achieve self-actualization. These additional needs were originally taught as encompassed in Maslow's original self-actualization needs. As such, the original five-level Maslow Hierarchy of Needs model remains the definitive representation of human motivation, and the later adaptations illustrate aspects of self-actualization.

The Maslow hierarchy teaches that the first four layers of the pyramid are called “deficiency needs.” Individuals do not feel anything when these needs are met, but feel anxious if they are not met. The top level of the pyramid, self-actualization, are needs defined as “growth needs” or “being values” and when fulfilled do not go away, but are rather motivated or desired further. Loosely interpreted, an individual will move up the pyramid as their lower needs are fulfilled in search of the apex, self-actualization. The above information is included to provide an overview of the how the Maslow Need Hierarchy is applied and how individual emotions drive consumers.

Recognizing that the Maslow needs are the driving forces for human motivation and provide a correlation for consumer consumption, categorization of the data points under Maslow is one step in the method. After or during the collection of the items that will become the data points, and the correlating recordation in the database or in an additional embodiment on the launchpad an emotional driver (Maslow need) is matched to each item. Because the Maslow model recognizes all human emotional drivers, the categorization of a data point (item) must be placed in at least one of the five categories. Each Maslow category has key words that are distinguishable and provide bases for categorizing the item. Categorizing the item under a Maslow need can be accomplished by using a human or a computer program. In one embodiment, a human reviews the item and the corresponding data collected for the item and assigns the emotional driver that it most closely relates. The individual is known as the “reader.” Obviously, it is possible that certain items or data points can be categorized under more than one emotional driver. In those instances the items are either categorized under the emotional driver most closely related to the item or under more than one emotional driver.

In an optional embodiment, a computer program is used to categorize the data under the emotional driver, by associating the Maslow need with the item. The item is treated using a keyword, content, or Boolean word search that accounts for synonyms or similar distinguished needs. The program categorizes a point based on the key word usage associated with the item. Categories of key words can be assembled similar to the Maslow models discussed above. The computer program can further be a program that “learns” to associate as it conducts searches by including new items under those Maslow needs that are most closely related. Examples of categories under each Maslow need, is demonstrated in the pyramid seen in FIG. 4.

Regardless if a “reader” or computer program is used to categorize the item. The program is designed to categorize the item under one of the five Maslow needs (instinctual drivers). The program reviews the item, including all information collected on the data sheet, and correlates the item with one of the instinctual drivers. In one embodiment, the item is categorized under a single Maslow need. In this case, the item is categorized under the need that it most closely resembles. Typically, if the item is categorized under a single need, it will be placed under the highest level the need can achieve on the Maslow pyramid. In another embodiment, the item is categorized under more than one need.

Culture Segments—Identifying a Trend

After the information related to the item, including the emotional driver associated with the need is recorded the items are grouped into trends known as culture segments. Culture segments are groupings of similar items categorized under the same instinctual driver that motivate a consumer in a similar manner and further include items from each area of the consumer life stimuli. These culture segments are viewed in terms of a trend. Culture segments include items from each of the areas including emerging, growing, and established/mainstream. By categorizing the items under a single basic instinctual need that further includes items from each of the consumer life stimuli a correlation is drawn between numerous items, and a culture group is identified. The culture group is then reviewed to determine the potential associated consumer affinity group and the resultant culture segment is given a title to represent how the culture segment is viewed by a consumer. After the culture segment is identified and titled the information is recorded as a culture segment and recorded in a data bank for later business development use.

In one embodiment, a culture group is created by identifying similar data points through a series of search engine commands. The search is conducted through the use of typical search engines that use key word searching, meta data searching, phrase searches, content searches, or advance feature searching. Examples of such search engines include Google, Yahoo, MS, AskJeeves, and Hotbot. The search is conducted through a series of searches that continually narrow the results to focus the query and the resulting data points to the defined search parameters. The search provides a unique set of data points that include representative data points spanning the four consumer life stimuli of design, entertainment, technology, and well being, the incorporation of a single Maslow emotional driver, and varying levels of emerging, growing, and mainstream data points.

In another embodiment, the culture segment is created by identifying an emerging item and matching similar emerging, growing, and established items with the emerging item. After a group of items are identified to have similar emotional motivation drivers on consumers, the group is titled and a trend or culture segment is identified. Creation of the culture segment by grouping the emerging item with similar items can be done by a human or a computer program. In one embodiment, a person will review the information contained on the data sheet or logged in the database and associated with the items, in particular the instinctual need, and the consumer life stimuli and compare this with other similar items to create the culture segment.

In another embodiment, a computer program is used to group an emerging item with similar emerging, growing, and established concepts to create a culture segment. The computer program functions by comparing and contrasting the information included in the data sheets or recorded in the database for a item, including the instinctual need associated with the item and include items from each of the consumer life stimuli groups, in order to group together similar items. The program group's items together by processing the information through keyword searches, content searches, and advanced search parameters that include the metadata that is continually monitored and updated by the database system.

In another embodiment, the culture segment is created or added to by identifying culture segments based on established items and growing items. The established items that are identified during the data collections steps are reviewed and grouped to form a culture segment or trend. The groups of items are established by associating items with similar instinctual needs, and include items from each of the consumer stimuli groups into a group, whereby forming the culture group. Creation of the culture groups can be done by a human or a computer program. In one embodiment, a person reviews the information collected on the data sheet for each established and growing item and groups the items with similar instinctual needs together to form the culture group and determines the potential associated consumer affinity group to determine the resultant culture segment. After the culture segments are identified, the emerging items are reviewed and matched with the established culture segments that are the most similar. Matching the emerging items with the already established culture segments is conducted by comparing and contrasting the information included in the emerging item data sheet or database with similar information associated with each culture segment.

In another embodiment, a computer program is used to group similar data points to create a culture segment or trend. The computer program functions by comparing and contrasting the information included in the data sheets or database for the data points, including the instinctual need associated with the item, the consumer life stimuli and the recorded tagged information and metadata in order to compile culture groups. The program compiles the culture groups by processing the information through keyword searches, content searches, and advanced search parameters. After the culture groups are created the additional items or data points can be added, as new items are input in the database. Matching the emerging concepts with the already established culture groups is conducted by comparing and contrasting the information included in the emerging concept data sheet with similar information associated with each culture group.

The above referenced methods create the culture segments and also can match emerging items with those culture segments. Creating the culture segment defines a specific demographic of consumers. And, matching the emerging item with a defined culture segment instantly creates consumer credibility in the emerging item and identifies a specific affinity group of consumers that will be interested in the emerging item. For example, items identified that included “green citizens,” hybrid automobiles, eco stores, green colleges, and organic foods were brought together to form the trend “mother earth.” These items all focus on the same instinctual need of security. The security need focuses on establishing stability and consistency in a chaotic world. By identifying the item with the same instinctual need a trend is defined and a consumer group or affinity group is identified that relates to this trend. Associating an emerging item with a culture segment helps identify a specific affinity group of consumers and the motivation associated with the emerging item that will influence the consumer.

Colony Culture Segments—Grouping of Trends

After the culture segments are identified the information and culture segments can further be grouped together to form colony culture segments. Forming the colony culture segments provide insight into a particular affinity group since each colony includes culture segments from varied instinctual needs that influence a particular affinity group. Creation of the a colony culture segment focuses on defining a specific affinity group of consumers based on the instinctual needs that motivate the affinity group. The colony culture segments formed focus on specific affinity groups that include consumers with similar values, life circumstances, motivation needs, and concerns. Further, the colony culture segments provide a means to evaluate how different events over the course of a lifetime will influence individuals and consumers in general to move from one colony to another and how this influences future purchasing patterns. By creating and monitoring the colony culture segments, marketing campaigns can be developed that focus on a specific affinity group. The marketing campaign is designed to shift as the stimuli in the consumers life shifts, creating a tailor made campaign for the targeted affinity group.

The grouping of culture segments into colony culture segments can be done by a human or a computer program. In one embodiment, a person will review the information for each culture segment and develop a colony culture segment that focuses on correlating related information between different culture segments to develop a colony culture segment. The colony culture segment created will be used to target a specific affinity group of consumers.

In another embodiment, a computer program is used to group the culture segments into colony culture segments. The computer program functions by comparing and contrasting the information included in the data sheets for each culture segment. The program groups the information based on parameters that includes, but is not limited to keyword searches, content searches, advanced searches, and concept clustering development.

Regardless if a person or computer is used to create the colony culture segments. The program is designed to define a specific affinity group of consumers. Information gained by defining a specific affinity group allows a business to develop future endeavors to target the affinity group of interest.

Business Development

Once the culture segments and colony culture segments have been identified the consumer affinity group associated with each can further be refined. Once a business has defined a specific affinity group a business can begin to develop future plans tailored to these groups. In one embodiment, a marketing campaign for a new product or service can be created that targets the affinity group associated with a specific culture segment or colony. Targeting the affinity group of a specific culture segment allows a focused marketing campaign to be developed for an emerging concept based on the same or similar instinctual needs that motivate a consumer related to an established trend. Development of the market campaign is conducted by first identifying a product or service to sale to consumers and second creating a focused market campaign that motivates the consumer to purchase the product or service. The market campaign is developed based on targeting the instinctual need that correlates with the culture segment. Tailoring the market campaign to a specific affinity group based on an instinctual need rather than current methods that target age or geographic affinity groups creates a focused campaign with a targeted consumer resulting in lowered resources expended to market.

In optional embodiments, the information developed related to the culture segments, the colony culture segments, and the defined affinity groups are used to grow and sustain a business through informed business development. The information developed can be used for numerous proposes related to business development including but not limited to marketing, business creation, business growth, positioning, and strategic development. Each of these areas are important to the growth and sustainability of a business. By being able to target the interest of consumers a business can be created, develop, and succeed.

Definitions

“Demographics” refers to characteristics of human populations and population segments, especially when used to identify consumer markets.

“Affinity group” refers to a group of consumers with at least one common characteristic.

“Human basic instincts” as used herein refers to the inborn characteristics of a human.

“Maslow Principle” refers to the “Hierarchy of Needs” defined by Maslow that influence the motivation of humans, these needs include: physiological; safety; love; esteem; and, self-actualization. These motivations directly influence what a person will buy. In particular, these motivations can be used to group together a population that is defined by similar purchasing habits. For example, a particular class of people will focus on buying goods or services that are friendly to the environment.

“Culture segments” refers to a trend or a group of concepts that are driven by the same hierarchy need, and similarly influence an individual.

“Colony culture segment” refers to a group of culture segments that target a set affinity group.

“Emerging concept” refers to a novel concept, idea, product, or services that has the potential to gain mainstream recognition by consumers.

“Consumer stimuli” refers to sources that consumers typically view that include media outlets, advertisements, movies, television programs and media, books, magazines, internet websites, blogs, chat rooms, newspapers, or any other source with related, relevant, or viewed information by a consumer.

“Item” refers to emerging, growing, or mainstream trends, concepts, ideas, products, services, or any other consumer stimuli.

“Emotional drivers” refers to an instinctual need that as categorized by Maslow creates a motivation in an individual.

“Blog” refers to a web log or journal kept on the internet. This journal is often updated daily and contains all information that the person maintaining the BLOG (Blogger) wishes to share with the world. Also applies to websites dedicated to a particular topic and being updated with the latest news, views and trends.

“Tag, Tagging, Tagged” refers to the recordation of information and associating this recorded information with a specific item.

### EXAMPLES

The following are example of the identification, collection, analysis, and categorization of an emerging concept related to a culture segment. The example further includes information on correlating the emerging concept with a culture segment to create a targeted affinity group market campaign.

### Example 1

For this example the focus is on the topic of Green Hot. To begin data is collected. Data is collected from numerous sources used in the industry. Typical sources included, magazines, TV, radio, movies, advertisements, newspapers, websites, blogs, chat rooms, and other media. Data is collected and recorded on a data sheet or input into the database. The item is tagged with a collection of relevant information that is associated with the item and informative of the item discovered. The information tagging or information recorded includes inputting information on 1) where the concept was discovered; 2) what form of media was used to relay the concept; 3) what age group will the concept likely target; 4) what other similar media reference the concept; 5) how many times the concept was seen during the search; 6) the emotional driver as defined by Maslow Needs Hierarchy that is most closely associated with the item; 7) the date of discovery and date of creation; 8) the consumer life stimuli most closely relates, such as design, entertainment, technology, or well being; and, 9) a contextual overview of the item. Tagging of the item provides a general overview of the item for future reference.

After the item is tagged it is placed in the database, it is also possible to place the item in the database and then record the information required for tagging. Upon entry in the database, the item becomes a data point. The entry of the item in the database initiates the continual monitoring and updating of the data point. During this monitoring and updating stage, the computer operating the database tags additional information. This stage of information tagging or information recorded includes adding information and recording metadata on: 1) activity, this includes the activity overall, the activity generated by the specific item for both current activity over a predetermined time period such as a week or month and the lifetime activity of the item; 2) number of occurrences that reference the item; 3) number of related occurrences, such as other media stimuli that reference the item; 4) the applications types, activity, and number of occurrences that reference or in some way incorporate the item; and 5) any general information relevant to the item. Additionally, previous tagged information can be amended, modified, or deleted dependent on changes occurring related to the item in consumer stimuli areas, such as marketing.

After the item has been input in the database and the tags associated with the item have been record, both the initial and subsequent tagging, the item is re-saved as a data point. The database is a storage tank for numerous data points and can then be searched to compile groups of like data points with similar tags. The tags are incorporated into each data point as metadata that can then be used for indexing and searching.

The search is conducted through the use of typical search engines that use key word searching, meta data searching, phrase searches, content searches, or advance feature searches. Examples of such search engines include Google, Yahoo, MSN, AskJeeves, and Hotbot. The search is conducted through a series of searches that continually narrows the results to focus the query and the resulting data points. The search compiles a unique set of data points that include representative data points spanning the four consumer life stimuli of design, entertainment, technology, and well-being, and the incorporation of a single Maslow emotional driver. The search results from the present example included results of a single Maslow emotional driver of “safety,” and representative data points from each of the consumer life stimuli discussed above. These results provide a group of data points which contain numerous similarities and potentially similar influences on an individual in relation to the consumer life stimuli and Maslow emotional driver.

After the data points are grouped together according to the search query the grouped data points becomes a culture group that may become a culture segment. The culture group in this example, is reviewed by a review group that determines if based on the impact in the marketplace whether the culture group has the potential to become a culture segment. In this example after the reviewed group analyzed the culture group the impact on the consumer was found and the title of “Green Hot” was assigned to the culture segment.

Upon further analysis by the review panel the potential consumer affinity groups were defined that would be influenced by the Green Hot culture segment and this information along with relevant data associated with the Green Hot culture segment, such as the specific data points that make up the culture group and culture segment are prepare in a report form for customers. Customers then use this specific information related to culture groups, culture segments, consumer affinity groups, the emotional drivers that will drive the potential consumer to develop marketing plans, business creation, business growth, potions, and product or service development for the customer's specific market.

### Example 2

To begin data is collected. For this example the focus is on the topic of “sustainable energy-powered cell phones.” Data is collected from numerous consumer stimuli sources used in the industry, such as those described in example 1. After collecting an item, it is then tagged, as previously described in example 1.

After as much information is recorded on the data sheet for “sustainable energy-powered cell phones,” the data sheet is placed on the “lifeboard.” The lifeboard contains numerous data sheets at any one time corresponding to emerging concepts. After the “sustainable energy-powered cell phones” data sheet is recorded, it is continually monitored. Monitoring the “sustainable energy-powered cell phones” concept aides in the collection and recordation of additional information on the data sheet such as 1) how many times it appears for a given time period; 2) additional contextual information related to the concept; and, 3) if the concept has begun attracting mainstream attention.

The data sheet is then reviewed to ensure the information collected on the data sheet is correct and up-to-date. After all the information is confirmed regarding the “sustainable energy-powered cell phones” concept the data sheet is transferred to the launchpad. The launchpad is the holding place for a concept before it is assigned a Maslow need. All the information is further reviewed on the data sheet and used to categorize the concept under a Maslow need. The present concept of “sustainable energy-powered cell phones” is placed under the Maslow need category of safety. The concept, information associated with the concept, and the context for material that contain the concept relate to a return to nature.

After the concept “sustainable energy-powered cell phones” has been associated with a Maslow need, the information is recorded on the data sheet. The next step is to place the emerging concept, in this case “sustainable energy-powered cell phones,” with the most closely related culture segment. The culture segments in the present example have already been defined. For the concept “sustainable energy-powered cell phones” the culture wave it is categorized under “Green Hot.” Green Hot is defined as a culture segment that includes similar concepts such as “sustainable bakery,” “green citizens,” “eco Wal-Mart,” and Arby's Chicken Naturals. By being able to associate an emerging concept such as “sustainable energy-powered cell phones” with already established concepts or trends, a marketing campaign can be developed that will focus on the affinity group that associates with those previous concepts included in the Green Hot.

Thus, there has been shown and described a method and system for identifying, collecting, organizing, and analyzing consumer data to determine if a trend may be emerging that fulfills all objects and advantages sought therefore. The invention illustratively disclosed herein suitably may be practiced in the absence of any element, which is not specifically disclosed herein. It is apparent to those skilled in the art, however, that many changes, variations, modification, other uses, and applications to the method and system are possible, and also such changes, variations, modifications, other uses, and applications which do not depart from the spirit and scope of the invention are deemed to be covered by the invention, which is limited only by the claims which follow.

What is claimed is:

1. A method for identifying data utilized in business development comprising:
a. identifying and collecting data from a plurality of consumer stimuli sources;
b. analyzing the data to ensure that it is not an aberration, whereby the step comprises identifying at least two sources for a data point and the existence of the data more than once;
c. recording contextual information on the data in order to define and tag the data;
d. categorizing the data into at least one category according to a human basic instinct defined as a Maslow need that includes biological or physiological, safety, belonging or love, esteem, and self-actualization;
e. categorizing the data into at least one category according to consumer life stimuli that includes entertainment, technology, design, and well being; and,
f. grouping the categorized data into a culture segment.

2. The method of claim 1, further grouping the culture segment into a colony culture segment.

3. The method of claim 1, wherein the business development is selected from the grouping consisting of marketing, advertisement campaigns, new business creation, new product creation, new service creation, product reinvention, service reinvention, strategic business growth, and combinations therefore.

4. The method of claim 1, wherein the consumer stimuli sources are selected from the group consisting of media outlets, advertisements, movies, television and radio programs, books, magazines, internet websites, blogs, chat rooms, newspapers, and combinations thereof.

5. The method of claim 1, wherein the culture segments are data groups created based on similarities.

6. The method of claim 1, wherein the culture segments are data groups created based on at least one human basic instinct and data points that include each of the four consumer life stimuli categories.

7. The method of claim 1, wherein the colony culture segments are linked to a product or service in order to market a product or service.

8. A method for identifying affinity groups, comprising:
a. identifying and collecting data from a plurality of consumer stimuli sources;
b. analyzing the data to ensure that it is not an aberration, whereby the step comprising identifying at least two sources for a data point and the existence of the data point more than once;
c. recording contextual information on the data in order to define and tag the data;
d. categorizing the data into at least one category according to a human basic instinct defined as a Maslow need that includes biological or physiological, safety, belonging or love, esteem, and self-actualization;
e. categorizing the data into at least one category according to consumer life stimuli that include entertainment, technology, design, and well being;
f. grouping the categorized data into a culture segment; and,
g. identifying the affinity group associated with the culture segment.

9. The method of claim 8, wherein the culture segments are further grouped into colony culture segments and the affinity group associated with the colony culture segment is identified.

10. The method of claim 8, wherein the data categorized is classified on a spectrum from emerging trends to mainstream, well-established, trends.

11. The method of claim 8, wherein identification of the affinity group is used in business development, with the business development selected from the group consisting of marketing, advertisement campaigns, new business creation, new product creation, new service creation, product reinvention, service reinvention, strategic business growth, and combinations therefore.

12. The method of claim 8, wherein the consumer stimuli sources are selected from the group consisting of media outlets, advertisements, movies, television and radio programs, books, magazines, internet websites, blogs, chat rooms, newspapers, and combinations thereof.

13. The method of claim 8, wherein the culture segments are data groups created based on similarities.

14. The method of claim 8, wherein the culture segments are data groups created based on at least one human basic instinct and data points that include each of the four consumer life stimuli categories.

15. The method of claim 8, wherein the affinity group identified are linked to a product or service in order to market a product or service.

16. A method for identifying an emerging trend comprising:
a. collecting data from a plurality of consumer stimuli sources on the emerging trend;
b. recording information on the emerging trend to collect as much information associated with the emerging trend as possible and tagging the information to define the emerging trend;
c. monitoring the emerging trend on a continual bases updating the information every week in order to record additional information on the trend.

17. The method of claim 16, wherein the emerging trend is grouped with a culture segment.

18. The method of claim 16, further identifying the affinity group associated with the culture segment and emerging trend.

19. The method of claim 16, wherein the consumer stimuli sources are selected from the group consisting of media outlets, advertisements, movies, television and radio programs, books, magazines, internet websites, blogs, chat rooms, newspapers, and combinations thereof.

20. A computer system for identifying data utilized in business development comprising:
a. executing a search to identify and collect data from a plurality of consumer stimuli sources;
b. recording contextual information on the data in order to define and tag the data;
c. categorizing the data point into at least one category according to a human basic instinct defined as a Maslow need that includes biological and physiological, safety, belonging and love, esteem, and self-actualization;
d. categorizing the data into at least one category according to consumer life stimuli that includes entertainment, technology, design, and well being;
e. pooling the tagged data into a database;
f. executing a search to create similar data groups based on similarities that include a single unique human basic instinct and each of the four consumer stimuli categories creating a culture segment.

21. The system of claim 20, wherein the data is updated on weekly bases.

22. The system of claim 20, further used to identify emerging trends and the affinity group associated with the emerging trend.
